(19) United States
(12) Patent Application Publication
(10) Pub. No.: US 2026/0329563 A1
(43) Pub. Date: Oct. 22, 2026

(54) SYSTEM AND METHOD FOR AI-DRIVEN TRAFFIC ROUTING OPTIMIZATION IN SOFTWARE DEPLOYMENTS

(71) Applicant: JPMorgan Chase Bank, N.A., New York, NY (US)

(72) Inventors: Aditya LAD, Santa Clara, CA (US); Fei CHEN, Plano, TX (US); Roopa Hiremath CHANDRASEKARAIAH, Milpitas, CA (US); Kshama DWARAKANATH, Union City, CA (US); Akshath KUMAR, Campbell, CA (US)

(73) Assignee: JPMorgan Chase Bank, N.A., New York, NY (US)

(21) Appl. No.: 19/186,291

(22) Filed: Apr. 22, 2025

(51) Int. Cl. G06F 8/60; G06F 9/445; G06F 11/00

(52) U.S. Cl. CPC G06F 8/60; G06F 9/44505; G06F 11/008

(57) ABSTRACT

Various methods and processes, apparatuses/systems, and media for artificial intelligence (AI) based autonomous traffic management in deploying an application are disclosed. A processor generate a sentiment score, based on real-time data analysis of real-time data, the sentiment score indicating health of the application and identifying performance issues of the application; implements, in response to generating the sentiment score, an AI algorithm, an AI agent, and reinforcement learning algorithm that utilize a multi-modal machine learning model to continuously monitor performance, stability, and adaptability of the application in the dynamic deployment environment; combines sentiment analysis based on the sentiment score with technical metrics data corresponding to the health and performance of the application; autonomously restores stable configurations and predicting potential anomalies before they impact performance of the application in response to combining the sentiment analysis; and deploys the application in response to restoring the stable configurations and resolving the potential anomalies.

### TECHNICAL FIELD

This disclosure generally relates to software deployments, and, more particularly, to methods and apparatuses for implementing a platform, language, cloud, and database agnostic intelligent traffic orchestration module for autonomous traffic management in software deployments using artificial intelligence (AI).

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Deployment of a software product within an organization may prove to be a large project that may include multiple stages including, for example, an assess stage, a test stage, a pilot stage, and a deploy stage. This deployment process may require significant time and resources on a frequent basis, especially for a software deployment providing new features, such as deployments of new versions of existing software products. Moreover, complex software systems are often difficult to manage due to the large number of possible combinations of configurations settings. For example, different deployments of the same software resource may have different combinations of language settings, security settings, patch set updates and network settings, among other configuration settings. A failure to properly manage deployment configurations may expose a system to various problems including security vulnerabilities and performance degradation.

For example, traditional canary deployments are a software deployment strategy where a new version of an application is rolled out to a small subset of users (the “canaries”) before being released to the entire user base, allowing for early detection and mitigation of potential issues. However, this traditional canary deployments rely on static rules and manual intervention, leading to inefficient resource utilization and potential service disruptions. For example, typical orchestration systems and methods may allow users to manually define workflows or plans (i.e., sequence of actions) to execute a task. However, there appears to be no automation on automatically building those workflows or plans from received inputs during software deployments. Also, if the workflow has to be adapted to different inputs/outputs, it has to be manually modified to account for other inputs as the ones they were defined for, thereby adding complexity to the overall system or process, failing to resolve data integration or synchronization or transfer issues among various computer implemented tools having various heterogenous systems running therein and subjecting the overall systems to malicious cyber-attacks due to the manual nature of defining tasks.

Current systems and methods lack the capability to automatically analyze enterprise observability sentiment data and correlate it with technical metrics for endpoint deployment decisions. This results in inefficient resource utilization and an inability to adapt to dynamic changes in software deployments, leading to potential service disruptions and suboptimal performance.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic intelligent traffic orchestration module configured to manage traffic autonomously in software deployments using AI, but the disclosure is not limited thereto. The intelligent traffic orchestration module may be configured to employ multi-modal machine learning to optimize traffic distribution between stable and canary deployments by analyzing real-time performance metrics, user behavior patterns, and system health indicators, thereby eliminating inefficiencies and potential service disruptions associated with traditional canary deployments, which rely on static rules and manual intervention. The intelligent traffic orchestration module may also be configured to feature self-healing capabilities and predictive rollback mechanisms, allowing for dynamic and intelligent traffic orchestration, but the disclosure is not limited thereto.

In some embodiments, a method for AI-driven autonomous traffic management in deploying an application by utilizing one or more processors along with allocated memory is disclosed. The method may include: receiving real-time data corresponding to an application's current state, a dynamic deployment environment, and run-time metadata corresponding to the application; generating a sentiment score, based on real-time data analysis of the received real-time data, the sentiment score indicating health of the application and identifying issues that hinder successful deployment of the application and performance of the application; implementing, in response to generating the sentiment score, an AI algorithm, an AI agent, and reinforcement learning algorithm that utilize a multi-modal machine learning model to continuously monitor performance, stability, and adaptability of the application in the dynamic deployment environment; combining sentiment analysis based on the sentiment score with technical metrics data corresponding to the health and performance of the application; autonomously restoring stable configurations and predicting potential anomalies before they impact performance of the application in response to combining the sentiment analysis; and deploying the application in response to restoring the stable configurations and resolving the potential anomalies.

In some embodiments according to the method, the real-time data may include logs data, network events data and performance metrics data corresponding to the application providing information regarding the application's current state, etc., but the disclosure is not limited thereto.

In some embodiments according to the method, the AI algorithm may include a retrieval augmented generation algorithm that enhances performance of the multi-modal machine learning model by allowing the multi-modal machine learning model to access and incorporate external knowledge bases before generating responses, making outputs more accurate, relevant, and up-to-date, etc., but the disclosure is not limited thereto.

In some embodiments according to the method, the multi-modal machine learning model may be a large language model, but the disclosure is not limited thereto.

In some embodiments, the method may further include: training the multi-modal machine learning model with data corresponding to real-time performance metrics, user behavior patterns, and system health indicators corresponding to the application, wherein the multi-modal machine learning model optimizes traffic distribution between stable and canary deployments corresponding to the application by analyzing real-time performance metrics, user behavior patterns, and system health indicators.

In some embodiments according to the method, the AI agent may correspond to a system or program that autonomously performs tasks on behalf of a user or another system.

In some embodiments according to the method, the AI agent may utilize multi-dimensional stability scoring and sentiment analysis corresponding to the application to make informed decisions about traffic routing and deployment strategies.

In some embodiments the method may further include: building, by utilizing the AI agent, a decision tree based on the sentiment score that optimizes workflow traffic according to predefined policies, wherein the sentiment score reflects a relative strength of component interactions, with redundant paths providing resilience.

In some embodiments, a system for AI-driven autonomous traffic management in deploying an application is disclosed. The system may include: a processor; and a memory operatively connected to the processor via a communication interface, the memory storing computer readable instructions, when executed, may cause the processor to: receive real-time data corresponding to an application's current state, a dynamic deployment environment, and run-time metadata corresponding to the application; generate a sentiment score, based on real-time data analysis of the received real-time data, the sentiment score indicating health of the application and identifying issues that hinder successful deployment of the application and performance of the application; implement, in response to generating the sentiment score, an AI algorithm, an AI agent, and reinforcement learning algorithm that utilize a multi-modal machine learning model to continuously monitor performance, stability, and adaptability of the application in the dynamic deployment environment; combine sentiment analysis based on the sentiment score with technical metrics data corresponding to the health and performance of the application; autonomously restore stable configurations and predicting potential anomalies before they impact performance of the application in response to combining the sentiment analysis; and deploy the application in response to restoring the stable configurations and resolving the potential anomalies.

In some embodiments according to the system, the real-time data may include logs data, network events data and performance metrics data corresponding to the application providing information regarding the application's current state, etc., but the disclosure is not limited thereto.

In some embodiments according to the system, the AI algorithm may include a retrieval augmented generation algorithm that enhances performance of the multi-modal machine learning model by allowing the multi-modal machine learning model to access and incorporate external knowledge bases before generating responses, making outputs more accurate, relevant, and up-to-date, etc., but the disclosure is not limited thereto.

In some embodiments according to the system, the multi-modal machine learning model may be a large language model, but the disclosure is not limited thereto.

In some embodiments, the processor may be further configured to: train the multi-modal machine learning model with data corresponding to real-time performance metrics, user behavior patterns, and system health indicators corresponding to the application, wherein the multi-modal machine learning model optimizes traffic distribution between stable and canary deployments corresponding to the application by analyzing real-time performance metrics, user behavior patterns, and system health indicators.

In some embodiments according to the system, the AI agent may correspond to a program that autonomously performs tasks on behalf of a user.

In some embodiments according to the system, the AI agent may utilize multi-dimensional stability scoring and sentiment analysis corresponding to the application to make informed decisions about traffic routing and deployment strategies.

In some embodiments the processor may be further configured to: build, by utilizing the AI agent, a decision tree based on the sentiment score that optimizes workflow traffic according to predefined policies, wherein the sentiment score reflects a relative strength of component interactions, with redundant paths providing resilience.

In some embodiments, a non-transitory computer readable medium configured to store instructions for AI-driven autonomous traffic management in deploying an application is disclosed. The instructions, when executed, may cause a processor to perform the following: receiving real-time data corresponding to an application's current state, a dynamic deployment environment, and run-time metadata corresponding to the application; generating a sentiment score, based on real-time data analysis of the received real-time data, the sentiment score indicating health of the application and identifying issues that hinder successful deployment of the application and performance of the application; implementing, in response to generating the sentiment score, an AI algorithm, an AI agent, and reinforcement learning algorithm that utilize a multi-modal machine learning model to continuously monitor performance, stability, and adaptability of the application in the dynamic deployment environment; combining sentiment analysis based on the sentiment score with technical metrics data corresponding to the health and performance of the application; autonomously restoring stable configurations and predicting potential anomalies before they impact performance of the application in response to combining the sentiment analysis; and deploying the application in response to restoring the stable configurations and resolving the potential anomalies.

In some embodiments according to the non-transitory computer readable medium, the real-time data may include logs data, network events data and performance metrics data corresponding to the application providing information regarding the application's current state, etc., but the disclosure is not limited thereto.

In some embodiments according to the non-transitory computer readable medium, the AI algorithm may include a retrieval augmented generation algorithm that enhances performance of the multi-modal machine learning model by allowing the multi-modal machine learning model to access and incorporate external knowledge bases before generating responses, making outputs more accurate, relevant, and up-to-date, etc., but the disclosure is not limited thereto.

In some embodiments according to the non-transitory computer readable medium, the multi-modal machine learning model may be a large language model, but the disclosure is not limited thereto.

In some embodiments according to the non-transitory computer readable medium, the instructions, when executed, may cause the processor to further perform the following: training the multi-modal machine learning model with data corresponding to real-time performance metrics, user behavior patterns, and system health indicators corresponding to the application, wherein the multi-modal machine learning model optimizes traffic distribution between stable and canary deployments corresponding to the application by analyzing real-time performance metrics, user behavior patterns, and system health indicators.

In some embodiments according to the non-transitory computer readable medium, the AI agent may correspond to a system or program that autonomously performs tasks on behalf of a user or another system.

In some embodiments according to the non-transitory computer readable medium, the AI agent may utilize multi-dimensional stability scoring and sentiment analysis corresponding to the application to make informed decisions about traffic routing and deployment strategies.

In some embodiments according to the non-transitory computer readable medium, the instructions, when executed, may cause the processor to further perform the following: building, by utilizing the AI agent, a decision tree based on the sentiment score that optimizes workflow traffic according to predefined policies, wherein the sentiment score reflects a relative strength of component interactions, with redundant paths providing resilience.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic intelligent traffic orchestration module configured to manage traffic autonomously in software deployments using AI in accordance with an embodiment.

FIG. 2 illustrates a diagram of a network environment with a platform, language, database, and cloud agnostic intelligent traffic orchestration device in accordance with an embodiment.

FIG. 3 illustrates a system diagram for implementing a platform, language, database, and cloud agnostic intelligent traffic orchestration device having a platform, language, database, and cloud agnostic intelligent traffic orchestration module in accordance with an embodiment.

FIG. 4 illustrates a system diagram for implementing a platform, language, database, and cloud agnostic intelligent traffic orchestration module of FIG. 3 in accordance with an embodiment.

FIG. 5 illustrates a flow chart of a process implemented by the platform, language, database, and cloud agnostic intelligent traffic orchestration module of FIG. 4 for managing traffic autonomously in software deployments using AI in accordance with an embodiment.

FIG. 6A illustrates a pseudo code implemented by the platform, language, database, and cloud agnostic intelligent traffic orchestration module of FIG. 4 to save and restore to working state in accordance with an embodiment.

FIG. 6B illustrates a pseudo code implemented by the platform, language, database, and cloud agnostic intelligent traffic orchestration module of FIG. 4 to build agent task from event input to agent task action in accordance with an embodiment.

FIG. 6C illustrates a pseudo code implemented by the platform, language, database, and cloud agnostic intelligent traffic orchestration module of FIG. 4 to create a q-table to update event and action rewards using reinforcement learning feedback loop in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art may appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, traditional canary deployments are a software deployment strategy where a new version of an application is rolled out to a small subset of users (the “canaries”) before being released to the entire user base, allowing for early detection and mitigation of potential issues. However, this traditional canary deployments rely on static rules and manual intervention, leading to inefficient resource utilization and potential service disruptions. For example, typical orchestration systems and methods may allow users to manually define workflows or plans (i.e., sequence of actions) to execute a task. However, there appears to be no automation on automatically building those workflows or plans from received inputs during software deployments. Also, if the workflow has to be adapted to different inputs/outputs, it has to be manually modified to account for other inputs as the ones they were defined for, thereby adding complexity to the overall system or process, failing to resolve data integration or synchronization or transfer issues among various computer implemented tools having various heterogenous systems running therein and subjecting the overall systems to malicious cyber-attacks due to the manual nature of defining tasks. Regarding the application performance issues, the challenges may be that the application may connect to remote data center rather than the local data center; the query parameters may be misconfigured; private cloud pool or a specific executor may be experiencing hardware or software malfunctions, etc.

Current systems and methods lack the capability to automatically analyze enterprise observability sentiment data and correlate it with technical metrics for endpoint deployment decisions. This results in inefficient resource utilization and an inability to adapt to dynamic changes in software deployments, leading to potential service disruptions and suboptimal performance.

The disclosed embodiments overcomes the problems associated with current systems and methods by implementing a platform, language, cloud, and database agnostic intelligent traffic orchestration module configured to integrate advanced AI techniques for intelligent traffic orchestration. Unlike traditional methods, disclose embodiments provide: dynamic adaptability—the intelligent traffic orchestration module may automatically adjust to changes in the deployment environment, optimizing traffic patterns and minimizing disruptions; comprehensive analysis—the intelligent traffic orchestration module may combine sentiment analysis with technical metrics, providing a holistic view of application health and performance; self-healing and predictive capabilities—the intelligent traffic orchestration module may autonomously restore stable configurations and predict potential anomalies before they impact performance; enhanced decision-making—the intelligent traffic orchestration module may implement AI agents that may utilize multi-dimensional stability scoring and sentiment analysis to make informed decisions about traffic routing and deployment strategies; continuous improvement-the intelligent traffic orchestration module may implement feedback loops and reinforcement learning that allow the system to learn from past actions and improve over time; integration with enterprise tools-the intelligent traffic orchestration module may analyze data from tools like project tracking system, providing insights into code changes, testing data, and documentation sentiment.

While many of the exemplary embodiments discussed herein focus on applications in distributed database domain, it should be understood that the technology described herein may be applied to a wide variety of other application domains.

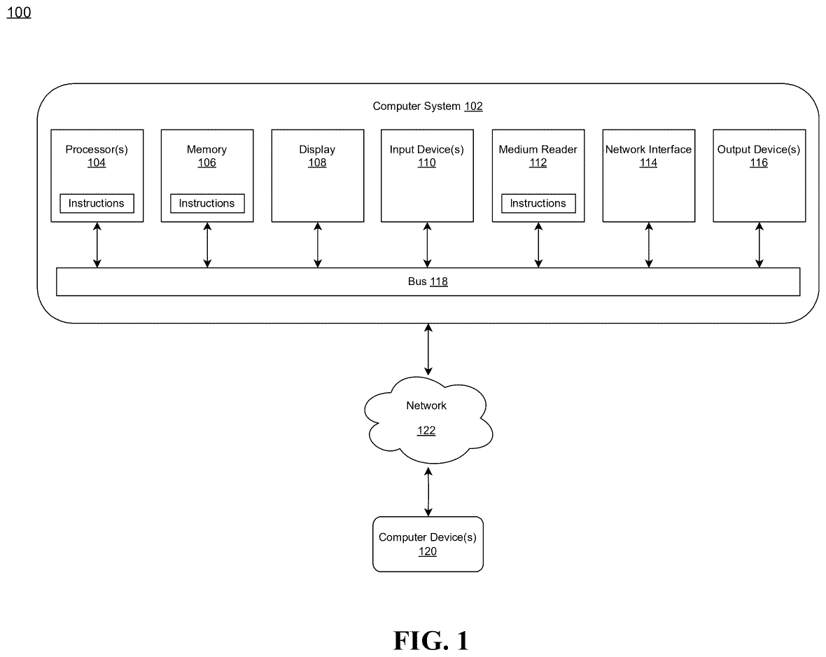

FIG. 1 is an exemplary system 100 for use in implementing a platform, language, database, and cloud agnostic intelligent traffic orchestration module configured to manage traffic autonomously in software deployments using AI without impacting application performance, but the disclosure is not limited thereto. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the intelligent traffic orchestration module may be platform, language, database, and cloud agnostic that may allow for consistent easy orchestration and passing of data through various components of the intelligent traffic orchestration module to output a desired result, i.e., alerts to remedy latency issues and application performance issues, regardless of platform, browser, language, database, and cloud environment. Since the disclosed process, in some embodiments, may be platform, language, database, browser, and cloud agnostic, the intelligent traffic orchestration module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

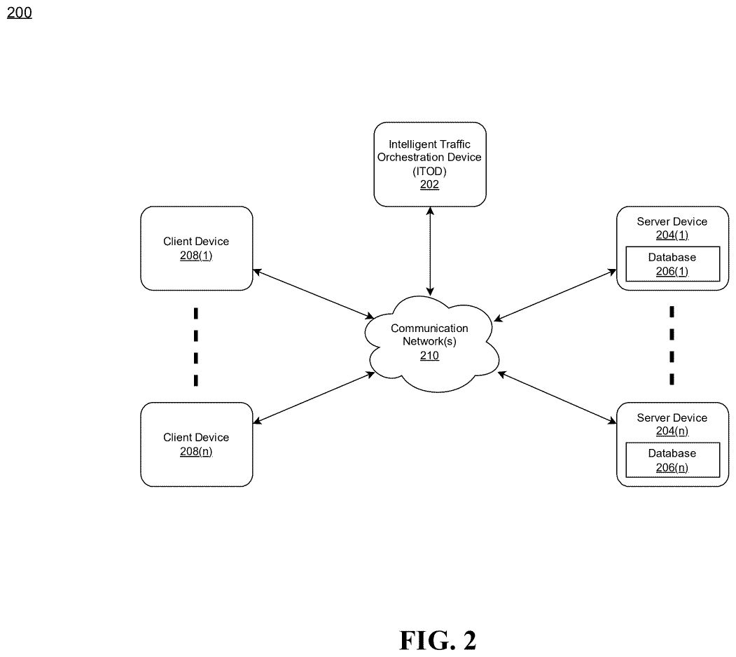

Referring to FIG. 2, a schematic of an exemplary network environment 200 for implementing a language, platform, database, and cloud agnostic intelligent traffic orchestration device (ITOD) of the instant disclosure is illustrated.

In some embodiments, the above-described problems associated with conventional tools may be overcome by implementing an ITOD 202 as illustrated in FIG. 2 that may be configured for implementing a platform, language, database, and cloud agnostic intelligent traffic orchestration module configured to manage traffic autonomously in software deployments using AI without impacting application performance, but the disclosure is not limited thereto. For example, the intelligent traffic orchestration module within the ITOD 202 disclosed herein may be configured to employ multi-modal machine learning to optimize traffic distribution between stable and canary deployments by analyzing real-time performance metrics, user behavior patterns, and system health indicators, thereby eliminating inefficiencies and potential service disruptions associated with traditional canary deployments, which rely on static rules and manual intervention. The intelligent traffic orchestration module may also be configured to feature self-healing capabilities and predictive rollback mechanisms, allowing for dynamic and intelligent traffic orchestration, but the disclosure is not limited thereto.

The ITOD 202 may have one or more computer system 102s, as described with respect to FIG. 1, which in aggregate provide the necessary functions.

The ITOD 202 may store one or more applications that may include executable instructions that, when executed by the ITOD 202, cause the ITOD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ITOD 202 itself, may be located in virtual server(s) running in a cloud-based computing environment rather than being tied to one or more specific physical network computing devices. Also, the application(s) may be running in one or more virtual machines (VMs) executing on the ITOD 202. Additionally, in one or more embodiments of this technology, virtual machine(s) running on the ITOD 202 may be managed or supervised by a hypervisor.

In the network environment 200 of FIG. 2, the ITOD 202 may be coupled to a plurality of server devices 204(1)-204(n) that hosts a plurality of databases 206(1)-206(n), and also to a plurality of client devices 208(1)-208(n) via communication network(s) 210. A communication interface of the ITOD 202, such as the network interface 114 of the computer system 102 of FIG. 1, operatively couples and communicates between the ITOD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ITOD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus may not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The ITOD 202 may be a standalone device or integrated with one or more other devices or apparatuses, such as one or more of the server devices 204(1)-204(n). In some embodiments, the ITOD 202 may be hosted by one of the server devices 204(1)-204(n), and other arrangements may also be possible. Moreover, one or more of the devices of the ITOD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the ITOD 202 via the communication network(s) 210 according to the HTTP-based and/or JSON protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the ITOD 202 that may efficiently provide a platform for implementing a platform, language, database, and cloud agnostic intelligent traffic orchestration module configured to manage traffic autonomously in software deployments using AI, but the disclosure is not limited thereto. For example, in some embodiments, the client devices 208(1)-208(n) in this example may include any type of computing device that may facilitate the implementation of the ITOD 202 that may efficiently provide a platform for implementing a platform, language, database, and cloud agnostic intelligent traffic orchestration module configured to employ multi-modal machine learning to optimize traffic distribution between stable and canary deployments by analyzing real-time performance metrics, user behavior patterns, and system health indicators, thereby eliminating inefficiencies and potential service disruptions associated with traditional canary deployments, which rely on static rules and manual intervention. The intelligent traffic orchestration module may also be configured to feature self-healing capabilities and predictive rollback mechanisms, allowing for dynamic and intelligent traffic orchestration, but the disclosure is not limited thereto.

The client devices 208(1)-208(n) may run interface applications, such as standard web browsers or standalone client applications, which may provide an interface to communicate with the ITOD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the ITOD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ITOD 202, the server devices 204(1)-204(n), or the client devices 208(1)-208(n), in some embodiments, may be configured to operate as virtual instances on the same physical machine. In some embodiments, one or more of the ITOD 202, the server devices 204(1)-204(n), or the client devices 208(1)-208(n) may operate on the same physical device rather than as separate devices communicating through communication network(s) 210. Additionally, there may be more or fewer ITODs 202, server devices 204(1)-204(n), or client devices 208(1)-208(n) than illustrated in FIG. 2. In some embodiments, the ITOD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

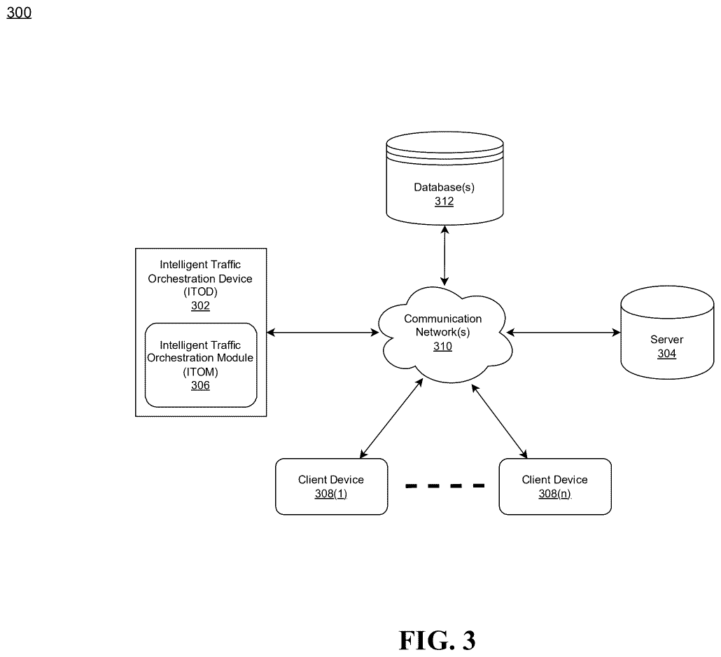

FIG. 3 illustrates a system diagram for implementing a platform, language, and cloud agnostic ITOD having a platform, language, database, and cloud agnostic intelligent traffic orchestration module (ITOM) in accordance with an embodiment.

As illustrated in FIG. 3, the system 300 may include an ITOD 302 within which an ITOM 306 may be embedded, a server 304, a database(s) 312, a plurality of client devices 308(1) . . . 308(n), and a communication network 310.

In some embodiments, the ITOD 302 including the ITOM 306 may be connected to the server 304, and the database(s) 312 via the communication network 310. The ITOD 302 may also be connected to the plurality of client devices 308(1) . . . 308(n) via the communication network 310, but the disclosure is not limited thereto.

According to exemplary embodiment, the ITOD 302 is described and shown in FIG. 3 as including the ITOM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the ITOM 306 may be configured to receive real-time feed of data from the plurality of client devices 308(1) . . . 308(n) and secondary sources via the communication network 310.

As may be described below, the ITOM 306 may be configured to: receive real-time data corresponding to an application's current state, a dynamic deployment environment, and run-time metadata corresponding to the application; generate a sentiment score, based on real-time data analysis of the received real-time data, the sentiment score indicating health of the application and identifying issues that hinder successful deployment of the application and performance of the application; implement, in response to generating the sentiment score, an AI algorithm, an AI agent, and reinforcement learning algorithm that utilize a multi-modal machine learning model to continuously monitor performance, stability, and adaptability of the application in the dynamic deployment environment; combine sentiment analysis based on the sentiment score with technical metrics data corresponding to the health and performance of the application; autonomously restore stable configurations and predicting potential anomalies before they impact performance of the application in response to combining the sentiment analysis; and deploy the application in response to restoring the stable configurations and resolving the potential anomalies, but the disclosure is not limited thereto.

The plurality of client devices 308(1) . . . 308(n) are illustrated as being in communication with the ITOD 302. In this regard, the plurality of client devices 308(1) . . . 308(n) may be “clients” (e.g., customers) of the ITOD 302 and are described herein as such. Nevertheless, it is to be known and understood that the plurality of client devices 308(1) . . . 308(n) need not necessarily be “clients” of the ITOD 302, or any entity described in association therewith herein. Any additional or alternative relationship may exist between either or both of the plurality of client devices 308(1) . . . 308(n) and the ITOD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the ITOD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ITOD 302 may be the same or similar to the ITOD 202 as described with respect to FIG. 2, including any features or combination of features described with respect thereto.

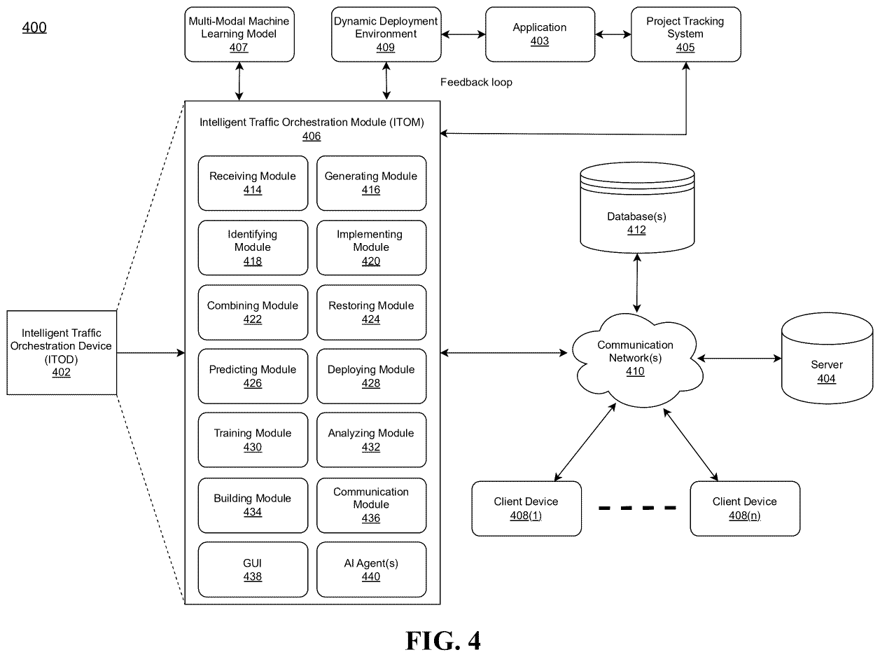

FIG. 4 illustrates a system diagram for implementing a platform, language, database, and cloud agnostic ITOM of FIG. 3 in accordance with an exemplary embodiment.

In some embodiments, the system 400 may include a platform, language, database, and cloud agnostic ITOD 402 within which a platform, language, database, and cloud agnostic ITOM 406 may be embedded, an application 403, a server 404, a project tracking system 405, a multi-modal machine learning model 407, a dynamic deployment environment 409, a communication network 410, and a database 412 (i.e., a distributed database). In some embodiments, the application server 404 may comprise a plurality of servers located centrally or located in different locations, but the disclosure is not limited thereto.

In some embodiments, the ITOD 402 including the ITOM 406 may be connected to the application 403, the server 404, the project tracking system 405, the multi-modal machine learning model 407, the dynamic deployment environment 409, and the database(s) 412 via a communication module 436 utilizing the communication network 410. The ITOD 402 may also be connected to the plurality of client devices 408(1)-408(n) via the communication network 410, but the disclosure is not limited thereto. The ITOM 406, the application server 404, the plurality of client devices 408(1)-408(n), the database(s) 412, the communication network 410 as illustrated in FIG. 4 may be the same or similar configuration to the ITOM 306, the server 304, the plurality of client devices 308(1)-308(n), the database(s) 312, the communication network 310, respectively, as illustrated in FIG. 3.

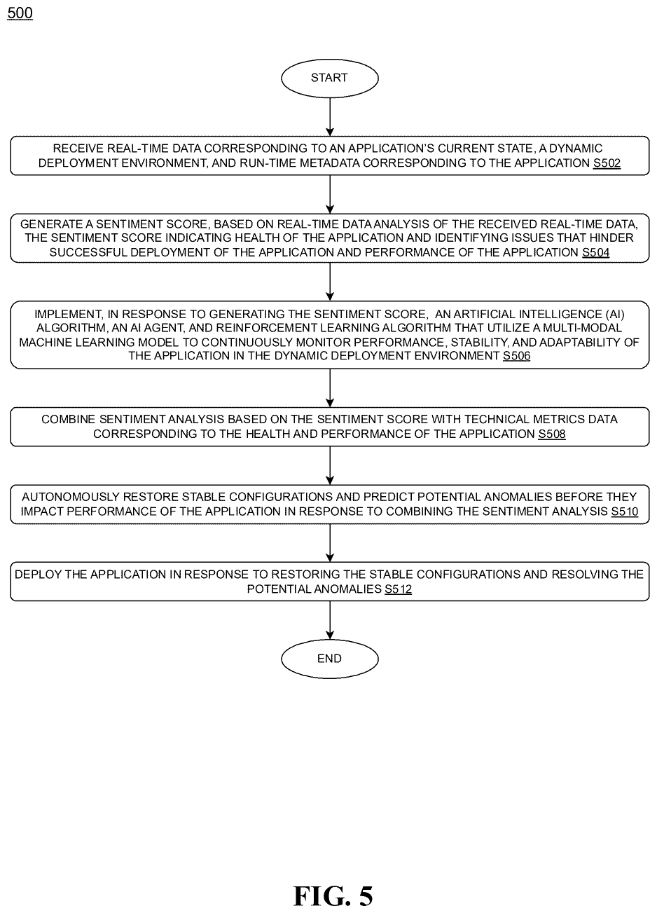

In some embodiments, as illustrated in FIG. 4, the ITOM 406 may include a receiving module 414, a generating module 416, an identifying module 418, an implementing module 420, a combining module 422, a restoring module 424, a predicting module 426, a deploying module 428, a training module 430, an analyzing module 432, a building module 434, a communication module 436, a Graphical User Interface (GUI) 438, and a plurality of AI agents 440. In some embodiments, interactions and data exchange among these modules included in the ITOM 406 provide the advantageous effects of the disclosed invention. Functionalities of each module of FIG. 4 may be described in detail below with reference to FIGS. 4-5.

In some embodiments, each of the receiving module 414, generating module 416, identifying module 418, implementing module 420, combining module 422, restoring module 424, predicting module 426, deploying module 428, training module 430, analyzing module 432, building module 434, and the communication module 436 of the ITOM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, generating module 416, identifying module 418, implementing module 420, combining module 422, restoring module 424, predicting module 426, deploying module 428, training module 430, analyzing module 432, building module 434, and the communication module 436 of the ITOM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 414, generating module 416, identifying module 418, implementing module 420, combining module 422, restoring module 424, predicting module 426, deploying module 428, training module 430, analyzing module 432, building module 434, and the communication module 436 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the ITOM 406 of FIG. 4 may also be implemented by cloud-based deployment.

In some embodiments, each of the receiving module 414, generating module 416, identifying module 418, implementing module 420, combining module 422, restoring module 424, predicting module 426, deploying module 428, training module 430, analyzing module 432, building module 434, and the communication module 436 the ITOM 406 of FIG. 4 may be called via corresponding API, but the disclosure is not limited thereto. For example, in some embodiments, the receiving module 414 may be called via a first API, the generating module 416 may be called via a second API, the identifying module 418 may be called via a third API, the implementing module 420 may be called via a fourth API, the combining module 422 may be called via a fifth API, the restoring module 424 may be called via a sixth API, the predicting module 426 may be called via a seventh API, the deploying module 428 may be called via an eight API, the training module 430 may be called via a ninth API, the analyzing module 432 may be called via a tenth API, the building module 434 may be called via an eleventh API, and the communication module 436 may be called via a twelfth API. In some embodiments, calls may also be made using event-based message interfaces in addition to APIs. An event-based message interface may be a design pattern that enables communication between services by defining events and handlers that process them utilizing the AI agents 440. This approach may allow for efficient communication and decoupled components, which may lead to more flexible and modular systems.

In some embodiments, the process implemented by the ITOM 406 may be executed via the communication module 436, and the communication network 410, which may comprise plural networks as described above. In some embodiments, in an exemplary embodiment, the various components of the ITOM 406 may communicate with the application 403, the server 404, the project tracking system 405, the multi-modal machine learning model 407, the dynamic deployment environment 409, the database(s) 412, and other systems of records (not shown) via the communication module 436 and the communication network 410 and the results may be displayed onto the GUI 438. Of course, these embodiments are merely exemplary and are not limiting or exhaustive. The database(s) 412 may include the databases included within the private cloud and/or public cloud and the server 404 may include one or more servers within the private cloud and the public cloud.

FIG. 5 illustrates a flow chart of a process 500 implemented by the ITOM 406 of FIG. 4 for managing traffic autonomously in software deployments using AI without impacting application performance in accordance with an embodiment. It may be appreciated that the illustrated process 500 and associated steps may be performed in a different order, with illustrated steps omitted, with additional steps added, or with a combination of reordered, combined, omitted, or additional steps.

In some embodiments, the interactions among the components of the ITOM 406 of FIG. 4 utilizing the steps of FIG. 5, cause the ITOM 406 to optimize traffic distribution between stable and canary deployments corresponding to the application 403 by analyzing real-time performance metrics, user behavior patterns, and system health indicators, thereby eliminating inefficiencies and potential service disruptions associated with traditional canary deployments, which rely on static rules and manual intervention. The ITOM 406 may also be configured to feature self-healing capabilities and predictive rollback mechanisms, allowing for dynamic and intelligent traffic orchestration, but the disclosure is not limited thereto.

For example, the ITOM 406 may be configured to implement a feedback loop and reinforcement learning by utilizing the plurality of AI agents 440, the muti-modal machine learning model 407, the dynamic deployment environment 408, that allows the ITOM 406 to implement AI techniques and retrieval-augmented generation technique to learn from past actions and improve over time. The ITOM 406 may also be configured to analyze data from the project tracking system 405, providing insights into code changes, testing data, and documentation sentiment corresponding to the application 403. The AI agent(s) may refer to a system or program that is capable of autonomously performing tasks on behalf of a user or another system.

For example, the ITOM 406 disclosed herein may be configured to integrate advanced AI techniques for intelligent traffic orchestration. Unlike traditional methods and systems mentioned earlier, the ITOM 406 disclosed herein may be configured to provide: dynamic adaptability—the ITOM 406 may automatically adjust to changes in the deployment environment, optimizing traffic patterns and minimizing disruptions; comprehensive analysis—the ITOM 406 may combine sentiment analysis with technical metrics, providing a holistic view of the health and performance of the application 403; self-healing and predictive capabilities—the ITOM 406 may autonomously restore stable configurations and predict potential anomalies before they impact performance of the application 403; enhanced decision-making—the ITOM 406 may implement the AI agents 440 that may utilize multi-dimensional stability scoring and sentiment analysis to make informed decisions about traffic routing and deployment strategies; continuous improvement—the ITOM 406 may implement feedback loops and reinforcement learning that allow the system to learn from past actions and improve over time; integration with enterprise tools—the ITOM 406 may analyze data from tools like the project tracking system 405, providing insights into code changes, testing data, and documentation sentiment, but the disclosure is not limited thereto.

The interactions among the components of the ITOM 406 of FIG. 4 utilizing the steps of FIG. 5 are disclosed below.

Referring to FIGS. 4-5, in some embodiments, at step S502, the process 500 may include receiving input events, by calling the receiving module 414 via the first API, real-time data corresponding to the application's 403 current state, the dynamic deployment environment 409, and run-time metadata corresponding to the application 403. In distributed systems issues related to hardware, networking, software, or processes used in the underlined infrastructure and dependent processes may happen often, in addition to non-application software related changes like increased data volume or user requests. The reliability and availability of the application 403 may depend on many factors. Under such circumstances, the environment and context metadata may be useful to be used to evaluate the state and conditions before deployment of the application 403 starts. Doing this may help application deployment to avoid using unstable or unknown environment.

In some embodiments, the real-time data may also include logs data, network events data and performance metrics data corresponding to the application providing information regarding the application's current state, etc., but the disclosure is not limited thereto.

In some embodiments, at step S504, the process 500 implemented by the ITOM 406 may include generating, by calling the generating module 416 via the second API, a sentiment score, based on real-time data analysis of the received real-time data, the sentiment score indicating health of the application and identifying, by calling the identifying module 418 via the third API, issues that hinder successful deployment of the application and performance of the application.

For example, at step S504, the process 500 implemented by the ITOM 406 may implement enterprise sentiment infrastructure sensing analysis (hereinafter, sentiment analysis) that may include: integration with the project tracking system's 405 ticket analysis, e.g., analyzing source code, commits, and testing data; and incorporating on-premise analysis tool designed to detect coding issues and testing fields for comprehensive insights, but the disclosure is not limited thereto.

At step S504, the process 500 implemented by the ITOM 406 may also implement confluence documentation sentiment tracking, e.g., monitoring sentiment in release documentation related to issues, special items, and major upgrades; and including features like proxy, major network, and storage updates corresponding to an organization, but the disclosure is not limited thereto.

At step S504, the process 500 implemented by the ITOM 406 may also implement internal knowledge base pattern recognition, e.g., detecting patterns in internal third-party changes and other microservices, including networking, but the disclosure is not limited thereto.

At step S504, the process 500 implemented by the ITOM 406 may also implement historical deployment correlation analysis, e.g., correlating historical data such as release versions, code changes, and deployment dates; considering factors like holidays, seasonal changes, and trends, but the disclosure is not limited thereto.

As mentioned earlier, at step S504, the process 500 implemented by the ITOM 406 may evaluate the input events to generate a sentiment score, indicating the application's 403 health and identifying potential issues. The input events may be grouped, categorized, or labeled into the domain of business impact related, infrastructure related, or self-owned application configurations and software. In some embodiments, the purpose of grouping or labeling may aim to build a reliability driven priority weight based sentiment benchmark and score systems. For example, when a network issue occurs it is likely the application 403 will not be available no matter how good the application software is written.

An implementation of software pseudocode, in some embodiments, may include the following:

```
Event_array = [
  Log_errors: low_weight,
  Network_proxy: high_weight,
  Load_balancers: high_weight,
  Firewall: high_weight,
  Cloud_network_control_list: high_weight,
  Dns_records: high_weight,
  HTTP_request_4xx_count: low_weight,
  HTTP_request_5xx_counts: high_weight
]
Deployment_policy = 0
Deployment_threshold = 0.8
For event in Event_array:
  Response = Run health check
  If Response successful:
    Deployment_policy += (1 / Count(Event_array)) *
    (low_weight or high_weight)
  If Response failed or no response:
    Deployment_policy −= 1 / Count(Event_array)
If Deployment_policy >= Deployment_threshold:
  Can_deploy = True
Else:
  Can_deploy = False
```

In some embodiments, at step S506, the process 500 implemented by the ITOM 406 may include, implementing by calling the implementing module 420 via the fourth API, in response to generating the sentiment score, a combination of an AI technique (i.e., algorithm), the plurality of AI agents 440, and reinforcement learning technique that utilizes the multi-modal machine learning model 407to continuously monitor performance, stability, and adaptability of the application 403 in the dynamic deployment environment 409.

In some embodiments according to the process 500 implemented by the ITOM 406, the AI algorithm may include a retrieval augmented generation algorithm that enhances performance of the multi-modal machine learning model 407 by allowing the multi-modal machine learning model 407 to access and incorporate external knowledge bases before generating responses, making outputs more accurate, relevant, and up-to-date, etc., but the disclosure is not limited thereto. In some embodiments according to the process 500, the multi-modal machine learning model 407 may be a large language model, but the disclosure is not limited thereto.

At step S508, the process 500 implemented by the ITOM 406 may include combining, by calling the combining module 422 via the fifth API, combining sentiment analysis based on the sentiment score with technical metrics data corresponding to the health and performance of the application 403.

For example, in some embodiments, the essential data for metric objection formation may include one or more of the following data: data center information data, query details data, status data, execution time data, host internet protocol data, etc., but the disclosure is not limited thereto. In some embodiments, the unnecessary data may include one or more of the following data: specific query types data; responses with a time greater than a configurable threshold, irrelevant metric types data, etc., but the disclosure is not limited thereto.

In some embodiments, the process 500 implemented by the ITOM 406 may further include: training, by calling the training module 430 via the ninth API, the multi-modal machine learning model 407 with data corresponding to real-time performance metrics, user behavior patterns, and system health indicators corresponding to the application 403, wherein the multi-modal machine learning model 407 optimizes traffic distribution between stable and canary deployments corresponding to the application by analyzing real-time performance metrics, user behavior patterns, and system health indicators.

In some embodiments, at steps 506 and 508, the process 500 implemented by the ITOM 406 may implement retrieval-augmented generation technique that may utilize AI to combine data retrieval with generative capabilities, providing insights and recommendations for complex scenarios by calling the combining module 422 via the fifth API. To improve the accuracy of events evaluation results, it may be helpful to build a custom domain knowledge to support and enhance the process communication and interaction. In some embodiments, application logs, network logs, container logs, API request logs may be source of truth and may send to large language models (LLMs) (i.e., multi-modal machine learning model 407) to summarize, group, and rank the important log events. This is useful when application engineers want to look up, sort, group, only failed or error log events in high volume data, and quickly. Utilizing retrieval-augmented generation custom knowledge may be useful to combine latest new data points into the existing evaluation workflows when the pre-trained multi-modal machine model 407 did not have these data points at training.

An implementation of software pseudocode, in some embodiments, may include the following:
Download logs, announcements, technical communications
Clean up logs, announcements, technical communications
Convert logs, announcements, technical communications to usable text
Use LLM model to summarize, group, and rank outputs
Build text embeddings from ranking outputs
For unknown_events loop:
   Call RAG to retrieve custom knowledge base
      If event found:
      Run existing health check against new endpoints or ask LLM Model to create lambda function to execute
   If event not found:
      Ask LLM model to look up other knowledge base
      Raise warning or error

In some embodiments, at step S510, the process 500 implemented by the

ITOM 406 may include: autonomously restore stable configurations by calling the restoring module 424 via the sixth API and predicting potential anomalies before they impact performance of the application in response to combining the sentiment analysis by calling the predicting module 426 via the seventh API.

In some embodiments, at step S512, the process 500 implemented by the ITOM 406 may include deploying the application 403 in response to restoring the stable configurations and resolving the potential anomalies by calling the deploying module 428 via the eighth API.

In some embodiments, as mentioned earlier, the AI agent(s) 440 may utilize multi-dimensional stability scoring and sentiment analysis corresponding to the application to make informed decisions about traffic routing and deployment strategies. For sentiment analysis, the analyzing module 432 may be called via the tenth API.

In some embodiments the process 500 implemented by the ITOM 406 may further include: building, by utilizing the AI agent 440 and by calling the building module 434 via the eleventh API, a decision tree based on the sentiment score that optimizes workflow traffic according to predefined policies, wherein the sentiment score reflects a relative strength of component interactions, with redundant paths providing resilience.

In some embodiments, the self-healing deployment implemented by the ITOM 406 discussed above may include automatically restoring stable configurations when disruptions occur, minimizing downtime and maintaining stability. To improve reliability and availability of the application 403 when dealing known or unknown issues, in some embodiments the process 500 implemented by the ITOM 406 may include restoring environment to previous state before outages, or rollback new changes. Rolling back may be selective, partial, or whole scope, when micro-service architecture is used.

By using AI reasoning and decision tree methods discussed above, a path of rollback or restoration may be built using data driven approach. For example, if there are two API paths modified in the new release, path_a and path_b, it is found path_a has issue but path_b works. When the application design and architecture is allowed, at step S510 of the process 500 implemented by the ITOM 406, the failed path_a, and all its children path should be included in the rollback or restore path.

An implementation of software pseudocode may include the following:

```
Success_release_table = {
  v1: success,
  v1:path_a/x: success,
  v1:path_a/x/y: success,
  v2: success,
  v2:path_b/x: success,
  v2:path_b/x/y: success,
  v3: new
}
Error_list = [unexpected_error for error in log_errors]
For Error in Error_list:
  Extract API path from error log events
  Build API path based decision tree
  path_a: [path_a/x, path_a/x/y, path_x/y/z]
  path_b: [path_a/x, path_a/x/y, path_x/y/z]
  If path_a FAIL:
    Rollback path_a microservices using release table
  If path_b NOT FAIL:
    No change
  Send request to LLM Agent to summarize, sort, and
  differentiate the results
  Send command to LLM Agent to trigger function calling
  Send results to LLM Agent to validate previous versions deployed
```

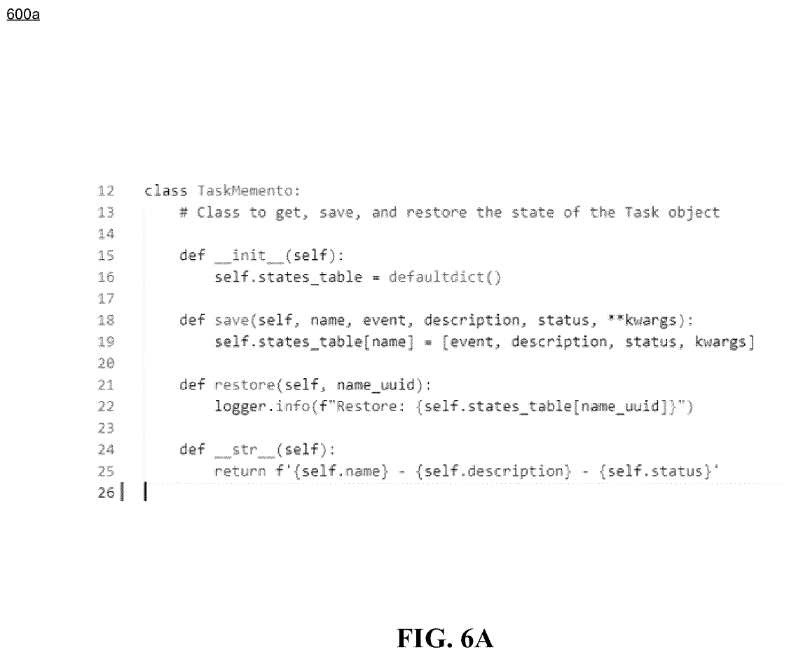

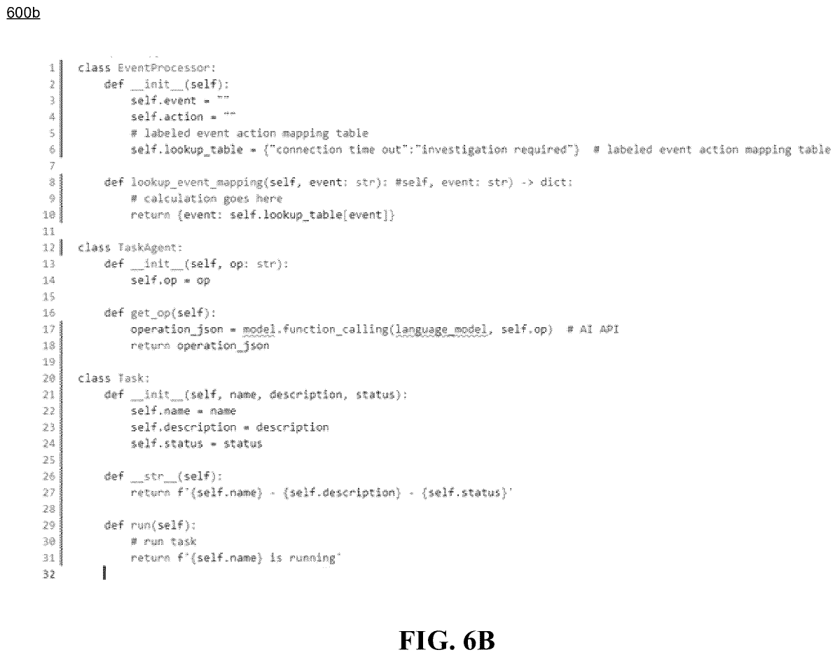

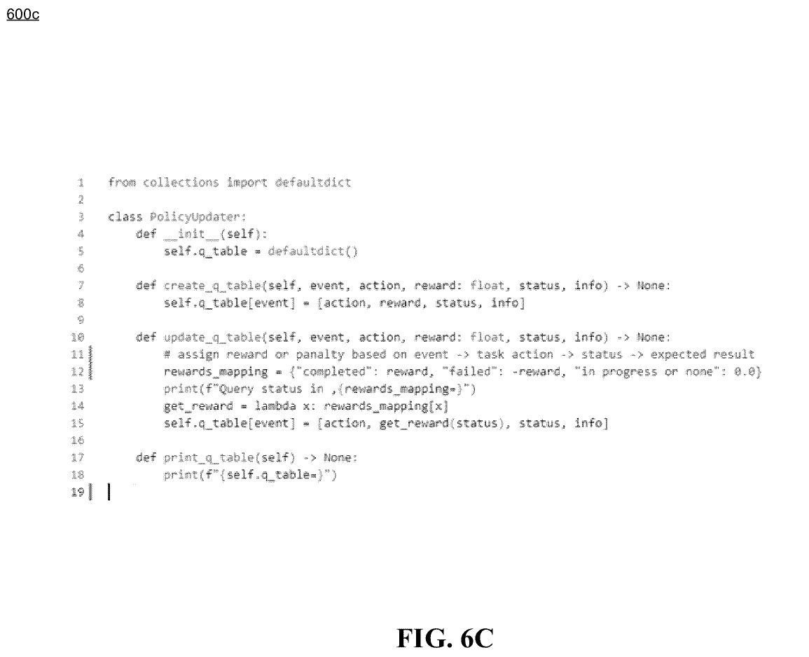

For example, FIG. 6A illustrates a pseudo code 600a implemented by the ITOM 406 of FIG. 4 to save and restore to working state in accordance with an embodiment.

In some embodiments, the automated stability verification implemented by the ITOM 406 discussed above may include continuously monitoring and evaluating stability of the application 403 using AI to detect and address issues proactively. Service level objective (SLO) may prove to be an important measurement to evaluate software system's performance and availability. SLO may be created using software programs like AI agents to execute request to specific targets using predefined rules, or self-generated rules including new endpoint path or host from runtime logs. The stability of application systems is not a timestamp, it may cover a time window when application performs expected behaviors and send responses within agreed service level agreements.

An implementation of software pseudocode may include the following:

```
Command_table = [curl, nslookup]
Endpoint_table = [ ] # empty
For event in logs:
  Extract API_path with successful response
  If API_path not found in Endpoint_table:
    Endpoint_table.append(API_path)
For API_path in Endpoint_table:
  For command in Command_table:
    Run AI Agent function calls
    If Result successful:
      Pass
    If Result FAIL:
      Raise Error or Warning
```

In some embodiments, the multi-dimensional stability score discussed above may provide a comprehensive assessment of reliability across various dimensions, offering a holistic view of stability. Distributed software systems may include many components from hardware, software, networking, process, and even engineers developing and supporting the systems. It may provide to be useful and meaningful to have a stability score including dimensions of technical, non-technical, even human factors. Because of requirements from industry, company, product owner, application development team, partner teams and end users, the stability score should include aspects from these factors.

An implementation of software pseudocode may include the following:

```
Dimension_table = [
  Infrastructure: on-prem, cloud,
  Industry: PCI, PII data protection,
  Company: Logging, monitor, audit,
  Development team: software, testing,
  Partners: vendors API, 3rd party library,
  End users: web page request, latency, data accuracy
]
Stability_score_table = [[dimension in Dimension_table] *
size of Dimension_table]
For dimension in Dimension_table:
  Call AI agent to query dimension
  Summarize query response in single keyword result
  Add to or Update in Stability_score_table
If Difference between Stability_score_table (yesterday) and
Stability_score_table(today) < 0:
  Raise Warning
```

In some embodiments, the AI agents 440 may perform data analysis, decision-making, and automation tasks, enhancing system adaptability and responsiveness. In some embodiments, an AI agent is not just a software program which may run utility, it may be integrated with LLM model, a group of models, and custom domain models to execute tasks following general instructions or guides. For example, the AI agents 440 as disclosed herein may be configured receive, query, create, execute, self-debug or correct own mistakes, and commit source codes.

An implementation of software pseudocode may include the following:
AI agent source code developed by human, or by AI
Define policy or rule AI agent must follow not break
Create logging and monitoring for AI agent
Run AI agent:
Receive instruction text (from human, system, or self)
Analyze instruction text if data is cleaned already
Clean up text data if required
Propose action based on instruction policy
Do:
   Create
   Read/Query
   Write
   Validate
   Restore/Rollback
   Self-learn/update policy
   Self-debug/correct error
   Raise Error/Warning
   Comply Rules

For example, FIG. 6B illustrates a pseudo code 600b implemented by the ITOM 406 of FIG. 4 to build agent task from event input to agent task action in accordance with an embodiment

In some embodiments, the loop back feedback and reinforcement learning discussed earlier may utilize feedback loops to learn from past actions, continuously improving system performance and stability. Learning and reinforcement learning may prove to be important to build and run software system efficiently and correctly. To enhance the ability of AI agent 440 and improve performance from previous actions and results, a reward mechanism may be utilized based on the policy objectives, actions taken, results or response received to build a reward table or model. The reward table may be constructed using common reinforcement learning concepts, for example states, agent, action, result, and rewards in numeric values.

An implementation of software pseudocode may include the following: reward_table=[AI agent, state, action, result, reward] [each agent in AI agent list]
For action by agent:
If result is Success:
   Reward+=0.1
Else If result is Fail:
   Reward−=0.1
Else:
   Reward−=0.1 #or 0.0 depending on policy
For future action by agent:
   Look up event input or state in reward table:
   Find the action with highest reward
   Execute the action
   Update Reward Table Based on Results

For example, FIG. 6C illustrates a pseudo code 600c implemented by the ITOM 406 of FIG. 4 to create a q-table to update event and action rewards using reinforcement learning feedback loop in accordance with an embodiment.

As discussed earlier, in some embodiments, the intelligent traffic management by the ITOM 406 as discussed above with reference to FIGS. 4-6 may include multi-dimensional stability scoring to assess reliability status at data center, regional, or global levels. Traditional health endpoint checks are insufficient for distributed applications, as any runtime component may impact latency, throughput, data accuracy, or overall application status. Multi-dimensional stability scoring as disclosed herein may prove to be essential to evaluate connected runtime environments. For example, the AI agents 440 discussed above may query, analyze, and reason in sequence or parallel to provide comprehensive stability scores. These scores may inform application monitoring systems for decision-making, including traffic routing optimization through rebalancing, moving, or adjusting behaviors.

As discussed earlier, in some embodiments, the intelligent traffic management by the ITOM 406 as discussed above with reference to FIGS. 4-6 may include adaptive traffic increment calculations that utilize reasoning to analyze logs, events, and responses for adaptive traffic management.

As discussed earlier, in some embodiments, the intelligent traffic management by the ITOM 406 as discussed above with reference to FIGS. 4-6 may include holistic application sentiment analysis. For example, the AI agents 440 may listen, watch, sense, and analyze to create a holistic application sentiment score (e.g., good, bad, okay) and provide data insights.

As discussed earlier, in some embodiments, the intelligent traffic management by the ITOM 406 as discussed above with reference to FIGS. 4-6 may implement dynamic application deployment and operation techniques. Traditional deployment processes are static, with limited adaptability to changes. The AI agents 440 as disclosed herein, either individually or orchestrated, may enhance flexibility through retrieval-augmented generation using LLMs and domain knowledge. This approach allows for adaptive modifications to configuration settings, networking policies, and even source code in response to production environment issues.

As discussed earlier, in some embodiments, the intelligent traffic management by the ITOM 406 as discussed above with reference to FIGS. 4-6 may include real-time deployment health monitoring by utilizing an elastic, weight-driven health monitoring mechanism that may aggregate data from multiple endpoints to assess overall environment health and application conditions.

As discussed earlier, in some embodiments, the intelligent traffic management by the ITOM 406 as discussed above with reference to FIGS. 4-6 may include predictive anomaly detection that may implement predictive models to identify anomalies before they impact application performance.

As discussed earlier, in some embodiments, the intelligent traffic management by the ITOM 406 as discussed above with reference to FIGS. 4-6 may include generating decision tree based on the application sentiment scores. For example, the AI agents 440 may be utilized to build decision trees based on application sentiment scores, optimizing workflow traffic according to predefined policies. Application sentiment scores may reflect the strength of component interactions, with redundant paths providing resilience.

As discussed earlier, in some embodiments, the intelligent traffic management by the ITOM 406 as discussed above with reference to FIGS. 4-6 may include progressive traffic shifting. For applications prioritizing traffic quality and performance, gradual traffic shifting may be preferred to avoid sudden changes and potential interruptions. The AI agents 440 may be configured to handle traffic flow events, analyze results, and fine-tune traffic patterns to meet performance requirements.

As discussed earlier, in some embodiments, the intelligent traffic management by the ITOM 406 as discussed above with reference to FIGS. 4-6 may include automated stability verification. Failures or interruptions from new software releases or intermediate components (e.g., Internet, networking, routers) may impact traffic stability. The AI agents 440 may be configured to capture traffic logs, pinpoint health checks, and predefined events to evaluate and define application stability automatically.

As discussed earlier, in some embodiments, the intelligent traffic management by the ITOM 406 as discussed above with reference to FIGS. 4-6 may include self-healing deployment mechanisms. Components as disclosed herein may interact using standard endpoint API calls for data communication and event triggering. Back-tracking algorithms may be implemented by the ITOM 406 to restore previously known good states when traffic is impacted by new endpoints. For large-scale distributed systems, traffic may be redirected to geographically separated data centers to mitigate impacts. Operators may define prescriptive software versions and traffic weights, allowing runtime traffic flows to be orchestrated automatically by the AI agents 440.

As discussed earlier, in some embodiments, the intelligent traffic management by the ITOM 406 as discussed above with reference to FIGS. 4-6 may include safety mechanisms that may implement smart rollback triggers using backpropagation to update rollback rules and weights. For example, the AI agents 440 may be configured to analyze deployment runtime data to automate rollback decisions, with all reasoning and decision-making processes logged for review and audit. This approach may enhance stability, particularly in non-production environments.

In some embodiments, the ITOD 402 may include a memory (e.g., a memory 106 as illustrated in FIG. 1) which may be a non-transitory computer readable medium that may be configured to store instructions for implementing a platform, language, database, and cloud agnostic ITOM 406 for AI-driven autonomous traffic management in deploying an application as disclosed herein. The ITOD 402 may also include a medium reader (e.g., a medium reader 112 as illustrated in FIG. 1) which may be configured to read any one or more sets of instructions, e.g., software, from any of the memories described herein. The instructions, when executed by a processor embedded within the ITOM 406 or within the ITOD 402, may be used to perform one or more of the processes as described herein. In a particular embodiment, the instructions may reside completely, or at least partially, within the memory 106, the medium reader 112, and/or the processor 104 (see FIG. 1) during execution by the ITOD 402.

In some embodiments, the instructions, when executed, may cause a processor embedded within the ITOM 406 or the ITOD 402 to perform the following: receiving real-time data corresponding to an application's current state, a dynamic deployment environment, and run-time metadata corresponding to the application; generating a sentiment score, based on real-time data analysis of the received real-time data, the sentiment score indicating health of the application and identifying issues that hinder successful deployment of the application and performance of the application; implementing, in response to generating the sentiment score, an AI algorithm, an AI agent, and reinforcement learning algorithm that utilize a multi-modal machine learning model to continuously monitor performance, stability, and adaptability of the application in the dynamic deployment environment; combining sentiment analysis based on the sentiment score with technical metrics data corresponding to the health and performance of the application; autonomously restoring stable configurations and predicting potential anomalies before they impact performance of the application in response to combining the sentiment analysis; and deploying the application in response to restoring the stable configurations and resolving the potential anomalies. In some embodiments, the processor may be the same or similar to the processor 104 as illustrated in FIG. 1 or the processor embedded within the ITOD 202, ITOD 302, ITOD 402, and ITOM 406 which may be the same or similar to the processor 104.

In some embodiments according to the non-transitory computer readable medium, the real-time data may include logs data, network events data and performance metrics data corresponding to the application providing information regarding the application's current state, etc., but the disclosure is not limited thereto.

In some embodiments according to the non-transitory computer readable medium, the AI algorithm may include a retrieval augmented generation algorithm that enhances performance of the multi-modal machine learning model by allowing the multi-modal machine learning model to access and incorporate external knowledge bases before generating responses, making outputs more accurate, relevant, and up-to-date, etc., but the disclosure is not limited thereto.

In some embodiments according to the non-transitory computer readable medium, the multi-modal machine learning model may be a large language model, but the disclosure is not limited thereto.

In some embodiments according to the non-transitory computer readable medium, the instructions, when executed, may cause the processor 104 to further perform the following: training the multi-modal machine learning model with data corresponding to real-time performance metrics, user behavior patterns, and system health indicators corresponding to the application, wherein the multi-modal machine learning model optimizes traffic distribution between stable and canary deployments corresponding to the application by analyzing real-time performance metrics, user behavior patterns, and system health indicators.

In some embodiments according to the non-transitory computer readable medium, the AI agent may correspond to a system or program that autonomously performs tasks on behalf of a user or another system.

In some embodiments according to the non-transitory computer readable medium, the AI agent may utilize multi-dimensional stability scoring and sentiment analysis corresponding to the application to make informed decisions about traffic routing and deployment strategies.

In some embodiments according to the non-transitory computer readable medium, the instructions, when executed, may cause the processor 104 to further perform the following: building, by utilizing the AI agent, a decision tree based on the sentiment score that optimizes workflow traffic according to predefined policies, wherein the sentiment score reflects a relative strength of component interactions, with redundant paths providing resilience.

In some embodiments as disclosed above in FIGS. 1-6C, technical improvements effected by the instant disclosure may include a platform for implementing a platform, language, database, and cloud agnostic intelligent traffic orchestration module configured to manage traffic autonomously in software deployments using AI, but the disclosure is not limited thereto. For example, as disclosed above in FIGS. 1-6C, technical improvements effected by the instant disclosure may include a platform for implementing a platform, language, database, and cloud agnostic intelligent traffic orchestration module configured to employ multi-modal machine learning to optimize traffic distribution between stable and canary deployments by analyzing real-time performance metrics, user behavior patterns, and system health indicators, thereby eliminating inefficiencies and potential service disruptions associated with traditional canary deployments, which rely on static rules and manual intervention. Moreover, as disclosed above in FIGS. 1-6C, technical improvements effected by the instant disclosure may include a platform for implementing a platform, language, database, and cloud agnostic intelligent traffic orchestration module configured to feature self-healing capabilities and predictive rollback mechanisms, allowing for dynamic and intelligent traffic orchestration, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it may not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for autonomous traffic management in deploying an application by utilizing one or more processors along with allocated memory, the method comprising:
receiving real-time data corresponding to an application's current state, a dynamic deployment environment, and run-time metadata corresponding to the application;
generating a sentiment score, based on real-time data analysis of the received real-time data, the sentiment score indicating health of the application and identifying issues that hinder successful deployment of the application and performance of the application;
implementing, in response to generating the sentiment score, an artificial intelligence (AI) algorithm, an AI agent, and reinforcement learning algorithm that utilize a multi-modal machine learning model to continuously monitor performance, stability, and adaptability of the application in the dynamic deployment environment;
combining sentiment analysis based on the sentiment score with technical metrics data corresponding to the health and performance of the application;
autonomously restoring stable configurations and predicting potential anomalies before they impact performance of the application in response to combining the sentiment analysis; and
deploying the application in response to restoring the stable configurations and resolving the potential anomalies.

2. The method of claim 1, wherein the real-time data includes logs data, network events data and performance metrics data corresponding to the application providing information regarding the application's current state.

3. The method of claim 1, wherein the AI algorithm includes a retrieval augmented generation algorithm that enhances performance of the multi-modal machine learning model by allowing the multi-modal machine learning model to access and incorporate external knowledge bases before generating responses, making outputs more accurate, relevant, and up-to-date.

4. The method of claim 1, wherein the multi-modal machine learning model is a large language model.

5. The method of claim 4, further comprising:
training the multi-modal machine learning model with data corresponding to real-time performance metrics, user behavior patterns, and system health indicators corresponding to the application, wherein the multi-modal machine learning model optimizes traffic distribution between stable and canary deployments corresponding to the application by analyzing real-time performance metrics, user behavior patterns, and system health indicators.

6. The method of claim 1, wherein the AI agent corresponds to a system or program that autonomously performs tasks on behalf of a user or another system.

7. The method of claim 1, wherein the AI agent utilizes multi-dimensional stability scoring and sentiment analysis corresponding to the application to make informed decisions about traffic routing and deployment strategies.

8. The method of claim 1, further comprising:
building, by utilizing the AI agent, a decision tree based on the sentiment score that optimizes workflow traffic according to predefined policies, wherein the sentiment score reflects a relative strength of component interactions, with redundant paths providing resilience.

9. A system for autonomous traffic management in deploying an application, the system comprising:
a processor; and
a memory operatively connected to the processor via a communication interface, the memory storing computer readable instructions that, when executed, cause the processor to:
receive real-time data corresponding to an application's current state, a dynamic deployment environment, and run-time metadata corresponding to the application;
generate a sentiment score, based on real-time data analysis of the received real-time data, the sentiment score indicating health of the application and identifying issues that hinder successful deployment of the application and performance of the application;
implement, in response to generating the sentiment score, an artificial intelligence (AI) algorithm, an AI agent, and reinforcement learning algorithm that utilize a multi-modal machine learning model to continuously monitor performance, stability, and adaptability of the application in the dynamic deployment environment;
combine sentiment analysis based on the sentiment score with technical metrics data corresponding to the health and performance of the application;
autonomously restore stable configurations and predicting potential anomalies before they impact performance of the application in response to combining the sentiment analysis; and
deploy the application in response to restoring the stable configurations and resolving the potential anomalies.

10. The system of claim 9, wherein the real-time data includes logs data, network events data and performance metrics data corresponding to the application providing information regarding the application's current state.

11. The system of claim 9, wherein the AI algorithm includes a retrieval augmented generation algorithm that enhances performance of the multi-modal machine learning model by allowing the multi-modal machine learning model to access and incorporate external knowledge bases before generating responses, making outputs more accurate, relevant, and up-to-date.

12. The system of claim 9, wherein the multi-modal machine learning model is a large language model.

13. The system of claim 12, wherein the processor is further configured to:
train the multi-modal machine learning model with data corresponding to real-time performance metrics, user behavior patterns, and system health indicators corresponding to the application, wherein the multi-modal machine learning model optimizes traffic distribution between stable and canary deployments corresponding to the application by analyzing real-time performance metrics, user behavior patterns, and system health indicators.

14. The system of claim 9, wherein the AI agent corresponds to program that autonomously performs tasks on behalf of a user.

15. The system of claim 9, wherein the AI agent utilizes multi-dimensional stability scoring and sentiment analysis corresponding to the application to make informed decisions about traffic routing and deployment strategies.

16. The system of claim 9, wherein the processor is further configured to:
build, by utilizing the AI agent, a decision tree based on the sentiment score that optimizes workflow traffic according to predefined policies, wherein the sentiment score reflects a relative strength of component interactions, with redundant paths providing resilience.

17. A non-transitory computer readable medium configured to store instructions for autonomous traffic management in deploying an application, the instructions, when executed, cause a processor to perform the following:
receiving real-time data corresponding to an application's current state, a dynamic deployment environment, and run-time metadata corresponding to the application;
generating a sentiment score, based on real-time data analysis of the received real-time data, the sentiment score indicating health of the application and identifying issues that hinder successful deployment of the application and performance of the application;
implementing, in response to generating the sentiment score, an artificial intelligence (AI) algorithm, an AI agent, and reinforcement learning algorithm that utilize a multi-modal machine learning model to continuously monitor performance, stability, and adaptability of the application in the dynamic deployment environment;
combining sentiment analysis based on the sentiment score with technical metrics data corresponding to the health and performance of the application;
autonomously restoring stable configurations and predicting potential anomalies before they impact performance of the application in response to combining the sentiment analysis; and
deploying the application in response to restoring the stable configurations and resolving the potential anomalies.

18. The non-transitory computer readable medium of claim 17, wherein the real-time data includes logs data, network events data and performance metrics data corresponding to the application providing information regarding the application's current state.

19. The non-transitory computer readable medium of claim 17, wherein the AI algorithm includes a retrieval augmented generation algorithm that enhances performance of the multi-modal machine learning model by allowing the multi-modal machine learning model to access and incorporate external knowledge bases before generating responses, making outputs more accurate, relevant, and up-to-date.

20. The non-transitory computer readable medium of claim 17, wherein the instructions, when executed, cause the processor to further perform the following:
training the multi-modal machine learning model with data corresponding to real-time performance metrics, user behavior patterns, and system health indicators corresponding to the application, wherein the multi-modal machine learning model optimizes traffic distribution between stable and canary deployments corresponding to the application by analyzing real-time performance metrics, user behavior patterns, and system health indicators.
